(19) United States
(12) Patent Application Publication
(10) Pub. No.: US 2025/0001770 A1
(43) Pub. Date: Jan. 2, 2025

(54) RECORDING APPARATUS

(71) Applicant: CANON KABUSHIKI KAISHA, Tokyo (JP)

(72) Inventors: YUSUKE NAKAYA, Tokyo (JP); SHOICHI ZENSAI, Kanagawa (JP); YOHEI KUSANO, Tokyo (JP)

(21) Appl. No.: 18/753,029

(22) Filed: Jun. 25, 2024

(30) Foreign Application Priority Data
Jun. 27, 2023 (JP) 2023-104944

(51) Int. Cl. B41J 11/00; B41J 2/21

(52) U.S. Cl. CPC B41J 11/0022; B41J 2/2117; B41J 11/00242

(57) ABSTRACT

Recording on a recording medium with multiple types of liquid can be performed separately for a first recording unit and a second recording unit, a part of the first recording unit and a part of the second recording unit are provided at different positions in a vertical direction, and a part of a region obtained by projecting the first recording unit in the vertical direction and a part of a region obtained by projecting the second recording unit in the vertical direction overlap with each other in a horizontal direction, and the recording medium conveyed out of the first recording portion is conveyed in a horizontal attitude until the recording medium has passed a predetermined distance in a first drying portion of the first recording unit.

### BACKGROUND OF THE INVENTION

### Field of the Invention

The present invention relates to a recording apparatus which performs recording by applying a liquid to a recording medium.

### Description of the Related Art

In a recording apparatus which performs recording by applying a liquid such as ink to a recording medium, there is such an apparatus that has a drying portion for promoting evaporation of a liquid component of the ink on a rear stage of a recording portion which performs ink application. Japanese Patent No. 6449942 discloses a recording apparatus which has a plurality of recording portions for performing multi-color printing on a recording medium and a drying portion provided on a rear stage of each of the recording portions.

In Japanese Patent No. 6449942, since a conveyance path is configured such that a recording medium passes through the drying portion on an immediate downstream of the recording portion, while being conveyed in an attitude inclined from the horizontal, there is a possibility that, depending on an applied amount of the ink, the ink moves on the recording medium along the inclination.

On the other hand, in the recording apparatus in Japanese Patent No. 6449942, by configuring the drying portion so that the recording medium is conveyed in a horizontal attitude, a plurality of the recording units, constituted by the recording portion and the drying portion, are provided by being aligned in the horizontal direction, there is a problem in that a size of the recording apparatus in the horizontal direction becomes larger.

### SUMMARY OF THE INVENTION

The present invention suppresses the size of a recording apparatus in the horizontal direction in a recording apparatus including a plurality of recording units having a recording portion, which applies a liquid to a recording medium, and a drying portion, which dries the recording medium to which the liquid was applied.

The present invention is a recording apparatus including:
a first recording unit having a first recording portion which performs recording by applying a liquid, while conveying a recording medium in a conveyance direction, and a first drying portion which is provided on a downstream of the first recording portion in the conveyance direction and dries the liquid applied to the recording medium; and
a second recording unit having a second recording portion which performs recording by applying the liquid, while conveying the recording medium in the conveyance direction, and a second drying portion which is provided on the downstream of the second recording portion in the conveyance direction and dries the liquid applied to the recording medium, wherein
recording on the recording medium with multiple types of the liquid can be performed separately for the first recording unit and the second recording unit,
in the recording apparatus, at least a part of the first recording unit and at least a part of the second recording unit are provided at different positions in a vertical direction, and at least a part of a region obtained by projecting a region, on which the first recording unit is disposed, in the vertical direction and at least a part of a region obtained by projecting a region, on which the second recording unit is disposed, in the vertical direction overlap with each other in a horizontal direction, and the recording medium conveyed out of the first recording portion is conveyed in a horizontal attitude until it has passed a predetermined distance in the first drying portion.

Further features of the present invention will become apparent from the following description of exemplary embodiments with reference to the attached drawings.

### BRIEF DESCRIPTION OF THE DRAWINGS

FIG. 1 is a schematic diagram illustrating an internal configuration of a recording apparatus;

FIG. 2 is a perspective view of a housing of a sheet conveying portion of a recording portion;

FIG. 3 is a perspective view of a recording-head elevation mechanism;

FIGS. 4A and 4B are schematic sectional views of a first drying portion and a second drying portion;

FIG. 5 is a schematic plan view of an air-flow space of a drying portion;

FIG. 6 is a sectional view of an air-flow duct of a cooling portion;

FIG. 7 is a schematic diagram illustrating a configuration of a first recording unit;

FIG. 8 is a schematic diagram illustrating a relative positional relation between the first recording unit and a second recording unit;

FIG. 9 is a block diagram of a control portion; and

FIG. 10 is a schematic diagram illustrating a relative positional relation between the first recording unit and the second recording unit of Embodiment 2.

### DESCRIPTION OF THE EMBODIMENTS

Hereinafter, Embodiments of the present invention will be specifically explained with reference to drawings. Note that constituent elements described in the following Embodiments are only exemplification, and constitutions and various conditions of an apparatus to which the present invention is applied can be modified or changed as appropriate within a range not departing from the gist of the present invention and are not limited to the following Embodiments. For example, dimensions, materials, shapes, relative disposition thereof and the like of constituent components described in the following Embodiments can be changed as appropriate depending on the configuration and various conditions of the apparatus to which the present invention is applied, and the present invention is not limited to the following Embodiments unless otherwise particularly described.

### Embodiment 1

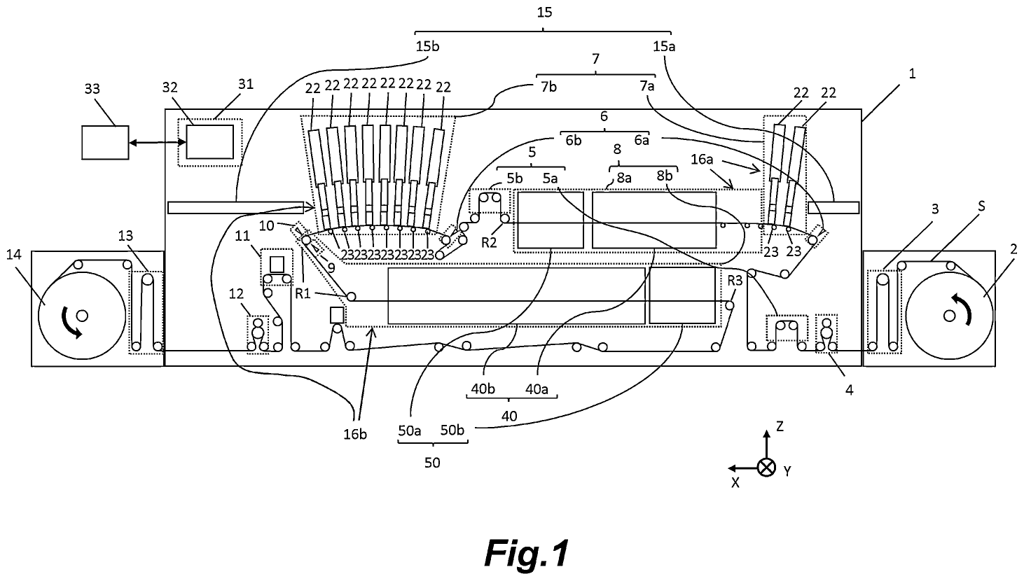

Hereinafter, Embodiments of the present invention will be specifically explained with reference to the drawings. A left-right direction in FIG. 1 is assumed to be an X-direction, a direction perpendicular to a paper surface of FIG. 1 as a Y-direction, and an up-down direction as a Z-direction. The X-direction is a longitudinal direction of a recording apparatus 1, and a direction from the right to the left in FIG. 1 is assumed to be positive. The Y-direction is a sheet-width direction orthogonal to a conveyance direction of a sheet S, and a direction from front of the sheet surface to a depth is assumed to be positive. In the Z-direction, a direction toward above the recording apparatus 1 is assumed to be positive. The recording apparatus 1 in Embodiment 1 is a high-speed line printer using as a continuous sheet wound in a roll state as a recording medium.

### Recording Apparatus

FIG. 1 is a schematic sectional diagram illustrating an internal configuration of the recording apparatus 1. The recording apparatus 1 includes an unwinding roll portion 2, a first dancer portion 3, a first main-conveying portion 4, a meandering correcting portion 5, a conveyance detecting portion 6, a recording portion 7, a fixing portion 8, a conveyance-tension detecting portion 9, a recorded-image position-detecting portion 10, a scanner portion 11, a second main-conveying portion 12, a second dancer portion 13, a winding roll portion 14, and a maintenance portion 15. The sheet S, which is a recording medium, is conveyed along a sheet conveyance path indicated by a solid line in the drawing and is processed in each unit.

The recording apparatus 1 in Embodiment 1 has a first recording unit 16a and a second recording unit 16b along the sheet conveyance path (sheet S). In the first recording unit 16a, ink applied to the sheet S is fixed through a first recording portion 7a, a first drying portion 40a, and a first cooling portion 50a, and an image is recorded on the sheet S. In the second recording unit 16b, ink applied to the sheet S having passed through the first recording unit 16a is fixed through a second recording portion 7b, a second drying portion 40b, and a second cooling portion 50b, and an image is recorded on the sheet S. In the recording apparatus 1 as above, images can be recorded in series on the sheet S by causing the sheet S to pass through the first recording unit 16a and the second recording unit 16b. Moreover, the recording apparatus 1 can record an image on the sheet S by using either one of the first recording unit 16a and the second recording unit 16b. In that case, in the recording unit which was not selected, the sheet S is only conveyed, and an image is not recorded. The selection of the recording unit is determined in accordance with a recording condition, for example. Note that, regarding the conveyance direction of the sheet S, a direction from the unwinding roll portion 2 to the winding roll portion 14 is defined as a forward direction, while a direction opposite to that as a backward direction.

The unwinding roll portion 2 is a unit for holding and supplying the sheet S wound in the roll state. The unwinding roll portion 2 is configured to accommodate a roll to be unwound and to pull out and supply the sheet S. Note that, the number of rolls that can be accommodated is not limited to one, but it may be so configured that two or three or more rolls are accommodated and the sheet S is selected, pulled out and supplied. Note that the unwinding roll portion 2 is rotated/controlled singularly by a drive motor (not shown) capable of forward rotation and reverse rotation.

The first dancer portion 3 is a unit for applying a certain sheet tension between the unwinding roll portion 2 and the first main-conveying portion 4. The first dancer portion 3 applies the sheet tension by tension applying means, not shown.

The first main-conveying portion 4 is a unit which sends the sheet S into each unit provided along the sheet conveyance path (sheet S) and applies the sheet tension between it and the second main-conveying portion 12. The first main-conveying portion 4 rotates by driving the motor, not shown, and performs tension conveying of the sheet S.

The meandering correcting portion 5 is a unit for correcting meandering in the sheet-width direction at tension conveyance of the sheet S. In Embodiment 1, regarding the meandering correcting portion 5, a first meandering correcting portion 5a is provided on an upstream of the first recording unit 16a, and a second meandering correcting portion 5b is provided on the upstream of the second recording unit 16b in the sheet conveyance path. The meandering correcting portion 5 includes a meandering-straightening roller and a meandering detection sensor, not shown, for detecting the meandering of the sheet S. The meandering-straightening roller can change inclination with respect to the sheet S by the motor, not shown, and performs meandering straightening of the sheet S on the basis of measurement by the meandering detection sensor. By causing the sheet S to be wound around the meandering-straightening roller, a function of the meandering straightening is improved.

The conveyance detecting portion 6 is a unit for detecting a conveyance speed of the sheet S and a mark printed on the sheet S in advance in order to control image forming timing of the recording portion 7. In Embodiment 1, in the conveyance detecting portion 6, a first conveyance-detecting portion 6a is provided on the upstream of the first recording unit 16a in the sheet conveyance path, and a second conveyance-detecting portion 6b on the upstream of the second recording unit 16b, respectively. The first conveyance-detecting portion 6a, the second conveyance-detecting portion 6b are used for controlling the image forming timing of the first recording portion 7a, the second recording portion 7b, respectively.

The recording portion 7 performs recording by applying the ink, while conveying the sheet S, which is a recording medium, in a conveyance direction. The recording portion 7 is a sheet processing portion which forms an image by applying a liquid (ink) to the sheet S by a recording head 22 from above to the sheet S being conveyed. The conveyance path in the recording portion 7 is formed by guide rollers 23 disposed in an arc shape projecting upward, and a clearance from the recording head 22 is ensured by a certain tension applied to the sheet S. The recording portion 7 has a plurality of the recording heads 22 disposed by being aligned along the conveyance direction. The first recording portion 7a has two line-type recording heads in total, corresponding to W (white) ink (white ink) and a reaction liquid. The second recording portion 7b has eight line-type recording heads in total, corresponding to the reaction liquid and three spot inks in addition to four color inks, which are Bk (black) (black ink), Y (yellow), M (magenta), C (cyan). The reaction liquid is a liquid containing such a component that increases viscosity of the ink and improves fixability of the ink.

Here, the increase in the ink viscosity is such a state that a color material, a resin and the like constituting the ink is brought into contact with a component which increases the viscosity of the ink, whereby chemical reaction or physical adsorption occurs, and a rise in the ink viscosity emerges. The increase in the ink viscosity is not limited to the rise in the viscosity of the entire ink but also includes the rise in local viscosity caused by partial coagulation of the component constituting the ink such as the color material, the resin or the like. The components which increase the ink viscosity are not particularly limited such as metal ions, high-molecular coagulants and the like, but a substance which causes a pH change of the ink and coagulates the color material in the ink can be used, and organic acids can be used. By applying a reaction liquid before the ink is applied to the sheet S, the ink having reached the sheet S can be immediately fixed. As a result, bleeding that adjacent inks are mixed with each other can be suppressed. Note that types/the number of colors and the number of the recording heads 22 are not limited.

For the ink-jet method, a method using a heat-generating element, a method using a piezoelectric element, a type using an electrostatic element, a method using a MEMS element or the like can be adopted. The ink is supplied from an ink tank, not shown, to the recording heads 22 through ink tubes, respectively.

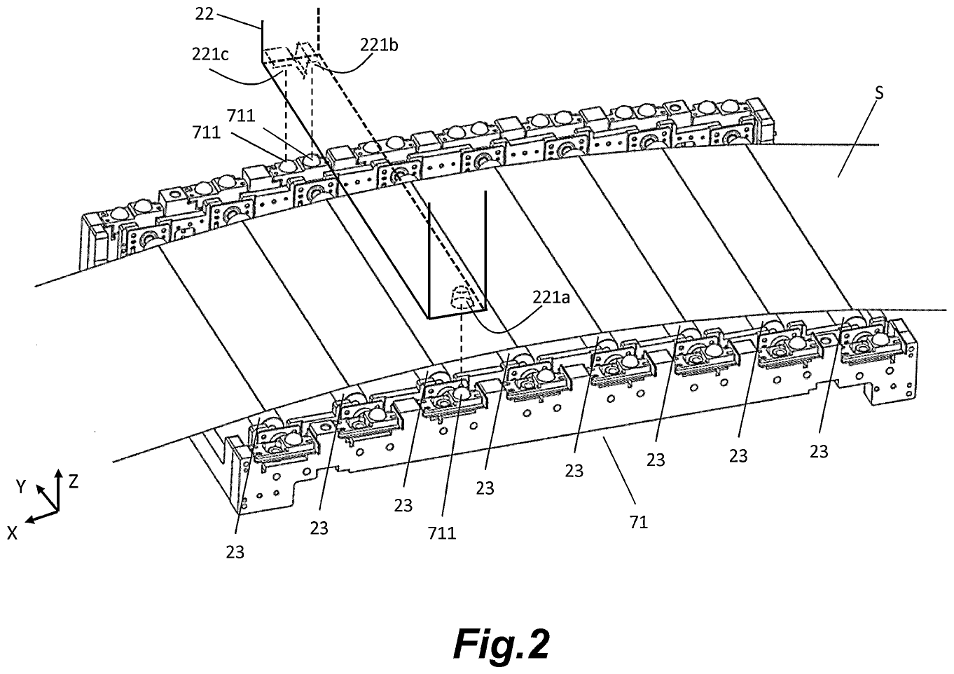

FIG. 2 is a schematic diagram illustrating a positioning configuration of the recording head 22 in the recording portion 7. In the recording portion 7, the guide rollers 23 disposed in the arc shape are held by a roller frame 71. On the roller frame 71, a plurality of recording-head positioning members 711 for positioning the recording heads 22 are provided. In Embodiment 1, with respect to one unit of the recording head 22, the recording-head positioning members 711 are disposed one on the front side and two on the depth side in the sheet-width direction (Y-direction) with the sheet S therebetween. In a lower part of the recording head 22, one recess portion 221a is provided on the front side and two recess portions 221b, 221c on the depth side in the sheet-width direction (Y-direction). The recording head 22 is positioned by fitting of the recording-head positioning member 711 in the recess portions 221a, 221b, 221c provided on the recording head 22.

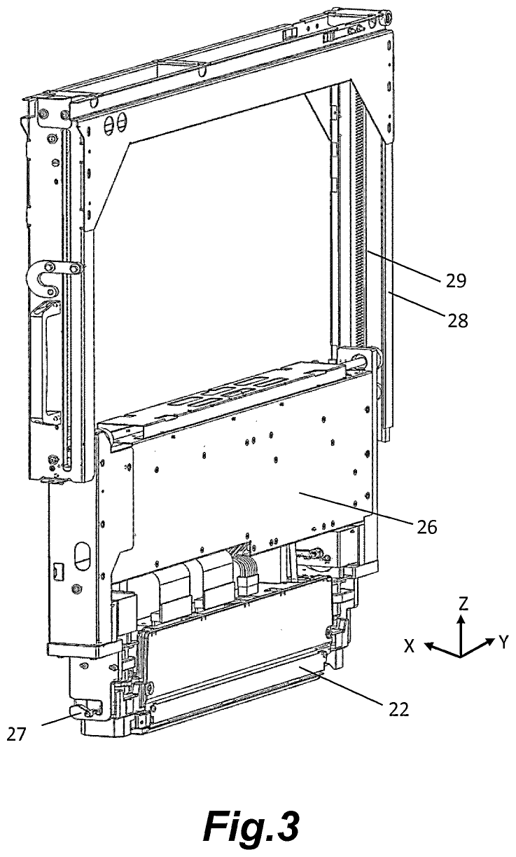

As shown in FIG. 3, the recording head 22 has a recording-head support shaft 27, and the recording-head support shaft 27 is supported by a recording-head holding portion 26 so as to be supported from below. The recording-head holding portion 26 performs an up-down elevation operation along a rail 29 for elevation provided in the recording-head elevation frame 28. This elevation operation is performed by a drive mechanism, not shown, provided in the recording-head holding portion 26. The recording head 22 is elevated in the up-down direction (Z-direction) in a state held by the recording-head holding portion 26.

In the recording apparatus 1 in Embodiment 1, the ink is applied to the sheet S by using an inkjet head, but a method of applying the ink to the sheet S is not limited to that. Moreover, in Embodiment 1, the reaction liquid is applied to the sheet S by the recording head 22, but it may be so configured that application is made by a roller, a die coating device (die coater), a blade coating device (blade coater) or the like.

The fixing portion 8 is provided on the downstream of the recording portion 7 in the conveyance direction and fixes the ink applied to the sheet S by drying. In Embodiment 1, the fixing portion 8 has a drying portion 40 for drying the ink and a cooling portion 50 which is provided on the downstream of the drying portion 40 in the conveyance direction and cools the sheet S.

The recording apparatus 1 includes the first recording unit 16a and the second recording unit 16b, each having the recording portion 7 and the fixing portion 8, and recording with multiple types of ink can be performed separately for the first recording unit 16a and the second recording unit 16b. The first recording unit 16a has the first recording portion 7a, a first fixing portion 8a (the first drying portion 40a, the first cooling portion 50a), and the second recording unit 16b has the second recording portion 7b, a second fixing portion 8b (the second drying portion 40b, the second cooling portion 50b). In the following explanation, when the first recording unit 16a and the second recording unit 16b and the constituent elements thereof are not distinguished, they are described as the recording unit 16, the recording portion 7, the fixing portion 8, the drying portion 40, the cooling portion 50 and the like in some cases.

The drying portion 40 is a unit which decreases a liquid portion contained in the ink applied to the sheet S in the recording portion 7 so as to improve fixing performances between the sheet S and the ink. The drying portion 40 blows air to the sheet S so as to dry the applied ink. Inside the drying portion 40, the air is blown to the passing sheet S at least from a side on which the ink is applied so as to dry the ink applied surface of the sheet S. Note that the drying method may be configured by combining a method of irradiating the sheet S surface with an electromagnetic wave (ultraviolet ray, an infrared ray or the like) and a conductive heat transfer method by contact of a heat generating body besides the air-blowing. Details of the drying portion 40 will be described later.

The cooling portion 50 cools the sheet S having been dried in the drying portion 40 so as to solidify the softened ink and to suppress a temperature change amount of the sheet S in a downstream process of the recording apparatus 1. Inside the cooling portion 50, the air at a temperature lower than that of the sheet S is blown to the passing sheet S at least from the ink-applied surface side so as to cool the ink applied surface of the sheet S. In order to increase the cooling efficiency of the sheet S, air may be blown to both sides of the sheet S. Note that the cooling method is not limited to air-blowing but may be the conductive heat-transfer method by contact of a radiating member or may be configured by combining them. Details of the cooling portion 50 will be described later.

The conveyance-tension detecting portion 9 is a unit for detecting a tension when the tension conveyance is performed between the first main-conveying portion 4 and the second main-conveying portion 12.

The recorded-image position-detecting portion 10 is a unit for detecting a shift in an image formed on the sheet S by the recording portion 7 during print and for causing the print to be corrected.

A winding guide-roller R1 is a roller for winding a surface to be a side opposite to the ink-applied surface of the sheet S on the downstream by a certain winding angle in the conveyance direction of the second recording portion 7b. In Embodiment 1, two units of the winding guide-rollers R1 are disposed between the second recording portion 7b and the second drying portion 40b, and the sheet S is folded back by 180 degrees between before and after the two winding guide-rollers R1. The sheet S on the upstream side of the two winding guide-rollers R1 and the sheet S on the downstream side are located above and below (positions in the Z-direction are different) and at positions substantially in parallel. The second drying portion 40b is disposed below (−Z-direction) with respect to the second recording portion 7b.

The scanner portion 11 is a unit which reads a test image formed on the sheet S in the recording portion 7 before formal print, detects a shift or density of the image and causes the formal print to be corrected.

The second main-conveying portion 12 is a unit which conveys the sheet S, while applying a tension to the sheet S in cooperation with the first main-conveying portion 4 and performs tension adjustment of the sheet S. The second main-conveying portion 12 rotates by driving by the motor, not shown, and controls a conveyance speed in accordance with a tension value detected by the conveyance-tension detecting portion 9, by a tension control portion, not shown. Note that, as an additional configuration for adjusting the tension of the sheet S, such a configuration that the tension of the sheet S is adjusted by a clutch (not shown) capable of controlling a driven/coupled torque may be added. In this case, as a tension control method, by using two methods, that is, a torque control method for controlling a torque value transmitted from the clutch and a speed control method for controlling a roller speed of the second main-conveying portion 12, the tension control method can be switched in accordance with a purpose or the both can be used at the same time.

The second dancer portion 13 is a unit for applying a certain sheet tension between the second main-conveying portion 12 and the winding roll portion 14. The second dancer portion 13 applies the sheet tension by tension applying means, not shown.

The winding roll portion 14 is a unit for winding a recorded-processed sheet S around a winding core. The number of the rolls which can be recovered is not limited to one, but it may be so configured that two or three or more winding cores are provided, and the sheet S is recovered through selection and switching. The winding roll portion 14 is rotated/controlled capable of forward and reverse rotation singularly by a drive motor (not shown). By forward-rotation control or reverse-rotation control of the drive motor (not shown) of each of the unwinding roll portion 2 and the winding roll portion 14, the sheet S is conveyed in the forward direction and is conveyed in the reverse direction. In the case of the reverse-direction conveyance, too, similarly to the forward-direction conveyance, the tension conveyance is performed between the first main-conveying portion 4 and the second main-conveying portion 12. Note that, depending on processing contents after recording, it may be so configured that, instead of the configuration of winding around the winding core, the sheet S is cut by using a cutter, and the cut sheet S is loaded.

A first maintenance portion 15a and a second maintenance portion 15b are units, each of which includes a mechanism for recovering discharge performances of the recording head 22 provided in the first recording portion 7a and the second recording portion 7b. As a mechanism as above, a cap mechanism which protects an ink discharge surface of the recording head 22, a wiper mechanism which wipes the ink discharge surface, and a suction mechanism which negative-pressure suctions the ink in the recording head 22 from the ink discharge surface can be cited. Moreover, the maintenance portion 15 includes a drive mechanism, not shown, and a rail and can reciprocate in the horizontal direction (X-direction) along the rail. The maintenance portion 15 moves to immediately below the recording head 22 at maintenance of the recording head 22 and moves to a position retreated from immediately below the recording head 22 when the maintenance operation is not performed.

A control portion 31 is a unit which manages control of each part in the recording apparatus 1. The control portion 31 has a CPU, a storage device, a controller including various control portions, an external interface, and an operation portion 32 on which a user inputs/outputs. An operation of the recording apparatus 1 is controlled on the basis of an instruction from a host device 33 such as a controller or a host computer connected to the controller via the external interface or the like.

### Configuration of Drying Portion 40

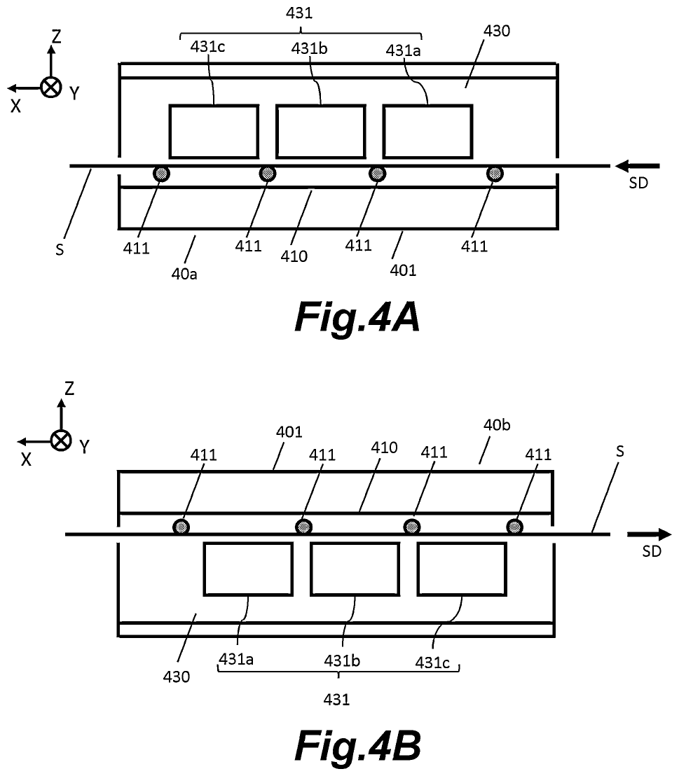

A configuration of the drying portion 40 will be explained. FIGS. 4A and 4B are sectional views perpendicular to the sheet-width direction (Y-direction), showing an internal structure of the drying portion 40. FIG. 4A shows the first drying portion 40a, and FIG. 4B shows an internal configuration of the second drying portion 40b. In FIGS. 4A and 4B, the sheet conveyance direction is indicated by an arrow SD. The drying portion 40 has a housing 401, and in the housing 401, a sheet supporting portion 410, in which a sheet-supporting roller 411 is disposed at a position in contact with the conveyed sheet S, and an air-flow space 430 are provided. The sheet supporting portion 410 limits displacement of the sheet S in the Z-direction by the sheet-supporting roller 411. In the first drying portion 40a, an interval is provided in the +Z direction (upward) from the sheet S conveyed by being opposed to the sheet supporting portion 410, and the air-flow space 430 is provided. Moreover, in the second drying portion 40b, an interval is provided in the −Z direction (downward) to the sheet S conveyed by being opposed to the sheet supporting portion 410, and the air-flow space 430 is provided. The air-flow space is a space in which one or more air-flow ducts 431 are stored. In Embodiment 1, in the air-flow space 430, three air-flow ducts 431a, 431b, 431c are installed. The drying portion 40 is configured by installing a plurality of the housings 401 aligned along the conveyance direction in accordance with determined productivity (conveyance speed of the sheet S). Note that the numbers of the air-flow spaces 430, the air-flow ducts 431, and the housings 401 are not limited. Details of the internal configuration of the first drying portion 40a will be described later.

### Configuration of Air-Flow Space 430

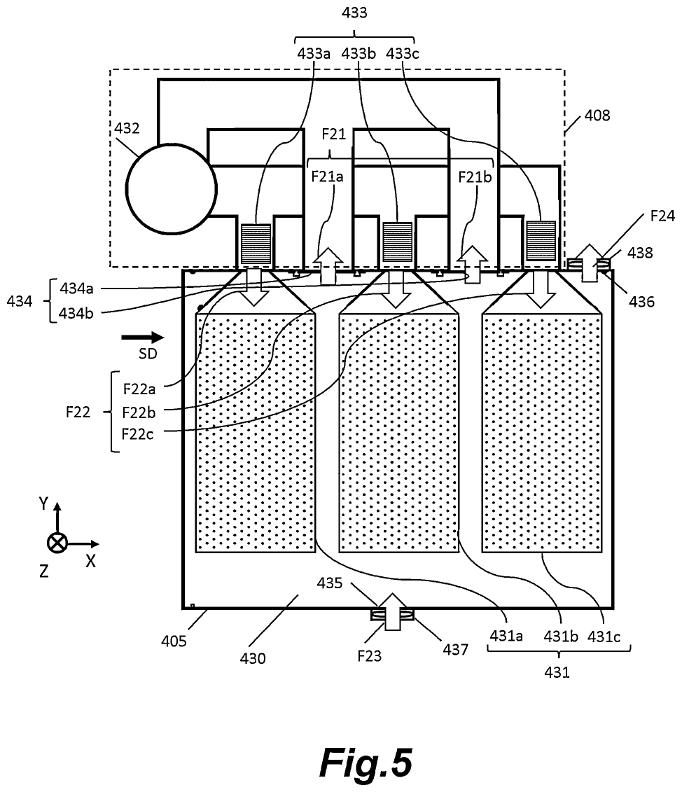

The configuration of the air-flow space 430 will be explained. FIG. 5 is a schematic diagram viewing the air-flow space 430 in the +Z direction from the sheet S. The air-flow space 430 has a second housing 405 and a plurality of the air-flow ducts 431 (431a, 431b, 431c) stored inside it.

In the second housing 405, a connection path (not shown) which sends air to the air-flow duct 431, a plurality of circulation exhaust ports 434 (434a, 434b), a ventilation port 435, and an exhaust port 436 are provided.

Outside the air-flow space 430, an air-circulation heating portion 408 on which an air blower 432 and a plurality of heaters 433 (433a, 433b, 433c) are mounted is provided. The air blower 432 takes in the air in the air-flow space 430 from the circulation exhaust port 434 in an arrow F21 direction (arrow F21a, F21b directions from the circulation exhaust ports 434a, 434b, respectively). The taken-in air is blown out from the air blower 432 to the air-flow duct 431 in an arrow F22 direction (arrow F22a, F22b, F22c directions to air-flow ducts 431a, 431b, 431c, respectively), and passes through the heater 433 at that time and is heated. A temperature of the heated air is detected by an air-temperature detecting portion, not shown. On the basis of the detected temperature, heating of the heater 433 is controlled in accordance with a predetermined target temperature.

The temperature of the air having passed through the heater 433 in Embodiment 1 is controlled in a range from 50 to 100° C. The heated air flows in the arrow F22 direction and is blown to the sheet S from the air-flow duct 431. In the air-flow duct 431, a plurality of round holes each with a small diameter (1.5 to 5 mm, for example) aligned regularly are made, and it is configured such that the air is uniformly blown out of the circular holes toward the sheet S. Note that the hole shape of the air-flow duct 431 is not limited to a round hole but may be a linear slit hole, an oval shape and the like or may be configured by combining them.

When a liquid portion of the ink on the sheet S evaporates, a steam pressure of the air-flow space 430 rises. If the steam pressure in the air-flow space 430 excessively rises, a desired evaporation amount cannot be obtained, and there is a possibility that sufficient drying cannot be performed. Thus, the air-flow space 430 is ventilated by taking in external air through an intake fan 437 provided in the second housing 405 and by exhausting the air in which steam collects by an exhaust fan 438.

The intake fan 437 takes in the external air in an arrow F23 direction through the ventilation port 435 and suctions it into the air-flow space 430. Here, the external air is the air having been taken into the recording apparatus 1 through an opening portion (not shown) provided in the recording apparatus 1.

The exhaust fan 438 exhausts the air in an arrow F24 direction through the exhaust port 436 from the air-flow space 430. The exhausted air is exhausted to outside the drying portion 40 through an exhaust duct (not shown).

Note that, in Embodiment 1, the ventilation is performed by the intake fan 437 and the exhaust fan 438, but the ventilation method is not limited to this example. For example, it may be so configured that the ventilation is performed by either one of fans of the intake fan 437 and the exhaust fan 438. Moreover, the ventilation port 435 and the exhaust port 436 may be provided on the air-circulation heating portion 408 side.

Moreover, an arbitrary drying form of blowing the air flow to the sheet S can be applied to the air-flow space 430. For example, the air-flow duct 431 and the air-circulation heating portion 408 are not limited to the aforementioned examples but may be realized by arbitrary installation numbers or by air-blowing means, heating means and the like. In addition, a drying method by a radiation-heating heater can be used at the same time or can be combined. Moreover, Example 1 has a form in which hot air is circulated by the heater 433, but it may be so configured that the heater 433 is not mounted but a normal-temperature air is circulated.

### Control of Drying Portion 40

A control procedure of the drying portion 40 executed by the control portion 31 will be explained. When recording data is transmitted from the host device 33 to the control portion 31, the recording apparatus 1 starts a preparation action for the recording.

The control portion 31 determines a drive condition of the drying portion 40 on the basis of the recording condition. The drive condition is determined on the basis of a type of the recording medium, recording density, and a user specified value. In the memory of the control portion 31, a relation between the recording condition and the drive condition determined in advance is recorded as a table, and the control portion 31 determines the drive condition according to the recording condition by referring to the table. The drive condition includes, for example, a target temperature and a target air amount of an air flow of the air-flow duct 431 and a drive control value of each unit such as the air blower 432, the heater 433 and the like. The control of the air blower 432 is executed by PWM control, for example, and a drive control value is specified as a duty taking a value between stop 0% to full-speed rotation 100%. Note that, in Embodiment 1, an example of determining the drive condition by referring to the table was illustrated, but this is not limiting. Other than the air amount adjustment of the air-flow duct 431 by the drive duty of the air blower 432, the following control can be considered. For example, by providing in-nozzle pressure detecting means, not shown, in the air-flow duct 431, the air blower 432 may be controlled by feedback control based on a target value of a pressure value inside the nozzle and a detected pressure value.

### Configuration of Cooling Portion 50

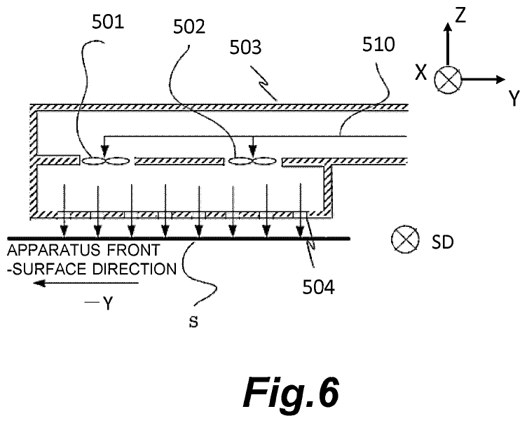

A configuration of the cooling portion 50 will be explained. The cooling portion 50 in Embodiment 1 constitutes an air-cooling portion by providing a plurality of air-flow ducts similarly to the drying portion 40. FIG. 6 is a diagram illustrating a configuration of the air-cooling portion 50. FIG. 6 is a schematic sectional diagram perpendicular to the conveyance direction (X-direction) of a cooling air-flow duct 503 and a diagram viewed from the conveyance direction of the sheet S. In an air path formed in the cooling air-flow duct 503, fans 501 and 502 are provided. The air taken in from the outside of the recording apparatus 1 is sent by the fans 501, 502 to a nozzle 504 as indicated by an arrow 510 and is blown from the nozzle 504 to the sheet S on the conveyance path.

### Control of Cooling Portion 50

A control procedure of the cooling portion 50 executed by the control portion 31 will be explained. When the recording data is transmitted from the host device 33 to the control portion 31, the recording apparatus 1 starts a preparation action for the recording.

The control portion 31 determines a drive condition of the cooling portion 50 on the basis of the recording condition. The drive condition is determined on the basis of a type of the recording medium, recording density, and a user specified value. In the memory of the control portion 31, a relation between the recording condition and the drive condition determined in advance is recorded as a table, and the control portion 31 determines the drive condition according to the recording condition by referring to the table. The drive condition includes, for example, drive control values of the fans 501 and 502 of the cooling air-flow duct 503. The control of the fans 501, 502 is executed by PWM control, for example, and a drive control value is specified as a duty taking a value between stop 0% to full-speed rotation 100%. Note that, in Embodiment 1, an example of determining the drive condition by referring to the table was illustrated, but this is not limiting. Other than the air amount adjustment of the cooling air-flow duct 503 by the drive duties of the fans 501, 502, the following control can be considered. For example, by providing in-nozzle pressure detecting means, not shown, in the cooling air-flow duct 503, the fans 501, 502 may be controlled by feedback control based on a target value of a pressure value inside the nozzle and a detected pressure value.

### Configuration of First Recording Unit 16a

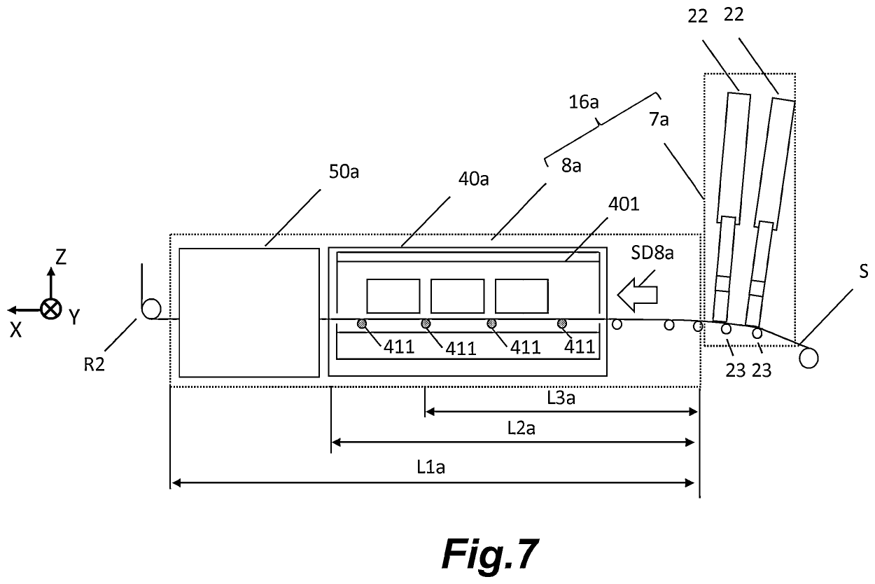

By using FIG. 7, a configuration of the first recording unit 16a will be explained. The first recording unit 16a is constituted by the first recording portion 7a and the first fixing portion 8a provided on the downstream in the conveyance direction of the first recording portion 7a. The first fixing portion 8a constitutes a conveyance path of the sheet S in a section from completion of ink application by the first recording portion 7a to the sheet S to a contact roller R2. The first fixing portion 8a includes the first drying portion 40a and the first cooling portion 50a. In FIG. 7, a conveyance direction SD8a of the sheet S in the first fixing portion 8a is indicated by an arrow.

In the first recording unit 16a, a reaction liquid and W ink are sequentially applied by the first recording portion 7a to the sheet S. The sheet S to which the reaction liquid and the ink were applied has the ink dried by the first drying portion 40a of the first fixing portion 8a. On the downstream in the conveyance direction SD8a of the first fixing portion 8a, the contact roller R2 is provided for conveyance-path formation for a sheet. The contact roller R2 is brought into contact with the ink applied surface of the sheet S. In order to keep an ink surface layer applied to the sheet S in a favorable state, the ink is preferably solidified by the time when the contact roller R2 is reached. Therefore, the first cooling portion 50a is provided on the downstream of the first drying portion 40a in the first fixing portion 8a, and the ink is solidified by the time when the contact roller R2 is reached. Here, the section from the completion of the ink application to the sheet S by the first recording portion 7a to the contact roller R2 via the first fixing portion 8a is defined as a first conveyance section L1a.

When the W ink in Embodiment 1 is white, in order to record in a desired density, a discharge amount is larger than those of inks in other colors. Therefore, the maximum application amount of the ink in the first recording portion 7a is larger than the maximum application amount of the ink in the second recording portion 7b.

In the case where an amount of the ink applied to the sheet S is large, when the sheet S is brought into an attitude inclined from the horizontal before fixing processing or during the fixing processing by the drying portion 40, there is a possibility that the ink before fixation moves along the inclination. In that case, there is a possibility that the ink moves and causes image failure. Thus, the attitude of the sheet S conveyed in the first conveyance section L1a was set with the substantial horizontal (a plane (XY plane) defined by the conveyance direction SD8a (X-direction) and the sheet-width direction (Y-direction) is substantially perpendicular to a gravity direction (Z-direction)). As a result, movement of the ink before fixation on the sheet S is suppressed, and preferable ink fixation and image recording can be realized.

Moreover, when an amount of the ink to be applied to the sheet S is large, there is a possibility that color mixing occurs between the inks. In this point, in the recording apparatus 1 of Embodiment 1, the application of the multiple types of ink to the sheet S and the fixation are performed separately for the first recording unit 16a and the second recording unit 16b. Therefore, while the ink applied amount is suppressed, and the color mixing of the inks is suppressed in each of the recording units 16, a large amount of ink can be fixed to the sheet S and favorable image can be formed. In the first conveyance section L1a where the sheet S is maintained in the substantially horizontal attitude, the plurality of sheet-supporting rollers 411 are disposed so as to be aligned along the conveyance direction SD8a. The plurality of sheet-supporting rollers 411 are disposed so that the support surface of the sheet S by the plurality of sheet-supporting rollers 411 becomes substantially in parallel (horizontal) to the XY plane.

Note that, in Embodiment 1, the example in which the sheet S is conveyed in the horizontal attitude in the first conveyance section L1a was illustrated, but it may be so configured that the conveyance is made in the horizontal attitude until the sheet S conveyed out of the first recording portion 7a has passed a predetermined distance at least in the first drying portion 40a. The predetermined distance is such a distance that, when the sheet S after having passed the distance in the first drying portion 40a is brought into the attitude inclined from the horizontal, the ink applied to the sheet S does not move along the inclination any more. In this case, it may be so configured that, in the conveyance path after having passed the predetermined distances in the first drying portion 40a, the sheet S is conveyed in the inclined attitude.

In the conveyance direction SD8a, a section from a position on the uppermost stream of the first conveyance section L1a (an outlet of the first recording portion 7a) to an outlet of the housing 401 located on the lowermost stream of the first drying portion 40a is defined as a drying section L2a. Moreover, in the conveyance direction SD8a, a section in which the sheet S is conveyed in the substantially horizontal attitude from a position on the uppermost stream of the drying section L2a (the outlet of the first recording portion 7a) is defined as a horizontal section L3a. The aforementioned predetermined distance is a conveyance distance of the sheet S in the horizontal section L3a. The predetermined distance is a distance where a predetermined amount of the ink applied to the sheet S evaporates when the sheet S passes the distance from an inlet (a position on the uppermost stream) of the first drying portion 40a. The predetermined amount is such an evaporation amount at which the ink applied to the sheet S does not move along the inclination any more, when the ink of the maximum application amount is applied in the first recording portion 7a, and the sheet S from which the predetermined amount of the ink has evaporated is brought into the attitude inclined from the horizontal.

Here, such an upper limit value of the ink applied amount that, even if the sheet S immediately after the ink was applied in the first recording portion 7a is brought into the attitude inclined from the horizontal, the ink does not move along the inclination is defined as W0 [g/m²]. The upper limit value W0 is a value determined in accordance with various conditions such as characteristics of the ink, characteristics of the sheet S, the inclination of the conveyance path and the like. Moreover, the maximum application amount of the first recording portion 7a is defined as W1 [g/m²]. The horizontal section L3a is such a distance that, when the sheet S on which the ink in the maximum application amount W1 was applied in the first recording portion 7a has passed the horizontal section L3a, a moisture amount remaining on the sheet S is equal to or smaller than an amount corresponding to the ink at the upper limit value W0. The horizontal section L3a only needs to be a predetermined distance or more required for the ink on the sheet S to evaporate to an amount equal to or smaller than the amount corresponding to the upper limit value W0 from the inlet of the first drying portion 40a (the position on the uppermost stream in the conveyance direction SD8a). If the predetermined distance is shorter than the drying section L2a, the horizontal section L3a can be made shorter than the drying section L2a within a range of the predetermined distance or more (L3a≤L2a).

Note that, in Embodiment, 1, as shown in FIG. 1, the sheet S is conveyed in the attitude inclined by the winding guide-roller R1 immediately on the downstream of the second recording portion 7b of the second recording unit 16b. Therefore, a maximum application amount W2 [g/m²] of the ink in the second recording portion 7b is equal to or smaller than the upper limit value W0. That is, the maximum application amount W2 of the ink by the second recording portion 7b is such an amount that, when the sheet S to which the ink in that amount was applied is brought into the attitude inclined from the horizontal in the second recording portion 7b, the ink applied to the sheet S does not move along the inclination.

Thus, the horizontal section L3a in the first fixing portion 8a may be a distance required for the ink on the sheet S to evaporate to an amount corresponding to the maximum application amount W2 or less of the second recording portion 7b from an inlet (a position on the uppermost stream in the conveyance direction SD8a) of the first drying portion 40a. In this case, assuming that a moisture evaporation speed by the first drying portion 40a is J [g/m²·sec], and a conveyance speed of the sheet S is V [m/sec], the horizontal section L3a is defined to satisfy a relation indicated by the following formula 1:

$$[ Math . 1 ]$$

$$V \cdot \frac{W 1 - W 2}{J} << L 3 a \leq L 2 a \qquad ( formula 1 )$$

Moreover, the drying section L2a is defined to satisfy the relation indicated by the following formula 2 so that, when the ink in the maximum application amount W1 is applied in the first recording portion 7a, all the moisture in the ink evaporates after passing through the drying section L2a:

$$[ Math . 2 ]$$

$$V \cdot \frac{W 1}{J} << L 2 a \qquad ( formula 2 )$$

The moisture evaporation speed J is a value determined by a shape of the air-flow duct 431, an air-flow temperature, an air-flow speed and the like of the drying portion 40. The drying section L2a is preferably given a sufficiently long distance by also considering heating time required for moisture evaporation of the ink applied to the sheet S. In Embodiment 1, on the basis of the formula 1 and the formula 2, the air-flow temperature, the air-flow speed of the air-flow duct 431 of the drying portion 40 and the conveyance speed of the sheet S are set so that the drying section L2a, the horizontal section L3a are contained in distances according to the size of the recording apparatus 1.

### Configuration of Second Recording Unit 16b

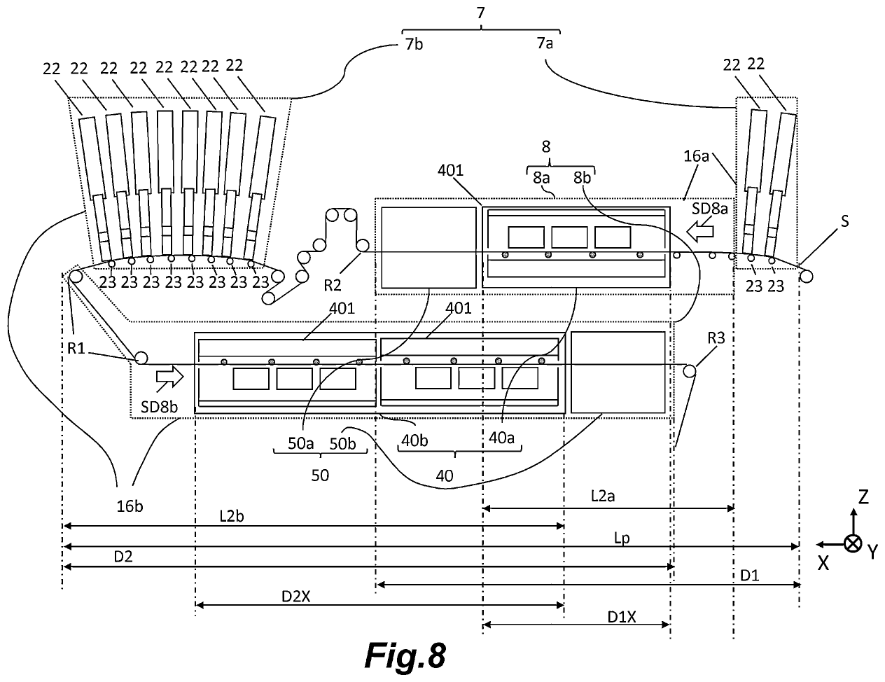

By using FIG. 8, a configuration of the second recording unit 16b will be explained. FIG. 8 is a schematic diagram illustrating a relative positional relation between the first recording unit 16a and the second recording unit 16b. The second recording unit 16b is constituted by the second recording portion 7b and the second fixing portion 8b provided on the downstream in the conveyance direction of the second recording portion 7b. The second fixing portion 8b constitutes a conveyance path of the sheet S in a section from completion of ink application by the second recording portion 7b to the sheet S to a contact roller R3. The second fixing portion 8b includes the winding guide-roller R1, the second drying portion 40b and the second cooling portion 50b. In FIG. 8, a conveyance direction SD8b of the sheet S in the second drying portion 40b is indicated by an arrow.

In the second recording unit 16b, the reaction liquid and color ink based on the recorded image are sequentially applied by the second recording portion 7b to the sheet S. The sheet S to which the ink was applied is folded back downward (−Z-direction) by the winding guide-roller R1 and then, the ink is dried by the second drying portion 40b in the second fixing portion 8b. On the downstream in the conveyance direction SD8b of the second fixing portion 8b, the contact roller R3 is provided for the sheet conveyance-path formation. The contact roller R3 is brought into contact with the ink applied surface of the sheet S. In the second recording unit 16b, too, in order to keep an ink surface layer applied to the sheet S in a favorable state, the ink is preferably solidified by the time when the contact roller R3 is reached. Therefore, the second cooling portion 50b is provided on the downstream of the second drying portion 40b in the second fixing portion 8b, and the ink is solidified by the time when the contact roller R3 is reached.

The second drying portion 40b has two pieces of the housings 401 disposed by being aligned along the conveyance direction SD8b in accordance with productivity (conveyance speed of the sheet S) required in the second recording unit 16b. Here, the section from the completion of the ink application to the sheet S by the second recording portion 7b to the outlet of the housing 401 located on the lowermost stream in the conveyance direction SD8b of the second drying portion 40b is defined as a drying section L2b. Moreover, a length in the X-direction (horizontal direction) of a region occupied by the first recording unit 16a and the second recording unit 16b in the recording apparatus 1 is defined as Lp.

In the recording apparatus 1, at least a part of the first recording unit 16a and at least a part of the second recording unit 16b are provided at different positions in the vertical direction. And between the conveyance direction of the sheet S in the at least a part of the first recording unit 16a and the conveyance direction of the sheet S in the second recording unit 16b, components in the horizontal direction opposed to each other. Moreover, a region D1 obtained by projecting a region on which the first recording unit 16a is disposed in the vertical direction and a region D2 obtained by projecting a region on which the second recording unit 16b is disposed in the vertical direction overlap with each other at least partially in the horizontal direction. That is, the first recording unit 16a and the second recording unit 16b are disposed such that at least parts of them are aligned in the vertical direction.

In Embodiment 1, the first recording unit 16a and the second recording portion 7b as well as the second drying portion 40b are provided at different positions in the vertical direction. And the conveyance direction SD8a of the sheet S in the first recording unit 16a and the second recording portion 7b and the conveyance direction SD8b of the sheet S in the second drying portion 40b are opposed to each other in the horizontal direction (X-direction). Moreover, the region Lp obtained by projecting the region on which the first recording unit 16a and the second recording portion 7b are disposed in the vertical direction and a region D2X obtained by projecting the second drying portion 40b in the vertical direction partially overlap with each other in the horizontal direction. That is, the first recording unit 16a and the second recording portion 7b are located above a part of the second recording unit 16b (second fixing portion 8b). On the downstream of the second recording portion 7b, the conveyance direction of the sheet S is folded back from the SD8a (+X-direction) to the SD8b (−X-direction), and the horizontal component in the conveyance direction is reversed.

Note that, as shown in FIG. 8, the disposition can be considered such that positions in the X-direction of the drying section L2a in the first drying portion 40a and the drying section L2b in the second drying portion 40b overlap with each other at least partially. Moreover, the disposition can be considered such that a region DIX obtained by projecting the region on which the first drying portion 40a is disposed in the vertical direction and a region D2X obtained by projecting the region on which the second drying portion 40b is disposed in the vertical direction partially overlap with each other in the horizontal direction. In this case, the first drying portion 40a of the first recording unit 16a and the second drying portion 40b of the second recording unit 16b are disposed by being aligned at least partially in the vertical direction.

By means of the disposition as above, the length Lp in the X-direction of the region occupied by the first recording unit 16a and the second recording unit 16b in the recording apparatus 1 can be made shorter than the configuration in which the two recording units are disposed by being aligned along the X-direction (horizontal direction). Therefore, the size in the horizontal direction of the recording apparatus 1 can be suppressed.

The conveyance path of the second recording unit 16b is folded back in the middle, the second recording portion 7b is provided above, and the second fixing portion 8b is provided below. Therefore, when sizes in an upper part and in a longitudinal direction of the apparatus are fixed, L2b can be configured longer than L2a, and the drying section L2b can be taken longer in the second drying portion 40b. Thus, the recording apparatus 1 may be configured such that recording can be performed only by the second recording unit 16b without using the first recording unit 16a. Productivity (conveyance speed of the sheet S) in this case can be set higher than the case where the recording is performed by using the first recording unit 16a and the second recording unit 16b without prolonging the length Lp in the X-direction. Note that, the disposition of each unit and the number of disposed units can be changed arbitrarily. For example, the number of the housings 401 of the drying portion 40 is not limited to the example in Embodiment 1 but may be an arbitrary number.

Moreover, in Embodiment 1, the configuration in which the drying section L2b by the second drying portion 40b is longer than the drying section L2a of the first drying portion 40a is exemplified, but the configuration in which the drying performance of the second drying portion 40b is made higher than that of the first drying portion 40a is not limited to that. For example, a heat amount for drying to be applied to the sheet S may be larger in the second drying portion 40b than the first drying portion 40a. For example, conditions such as a drying temperature, an air amount (drive duty) and the like of the second drying portion 40b may be set higher than the conditions of the first drying portion 40a. As a result, the second drying portion 40b can apply a heat amount higher than that of the first drying portion 40a to the sheet S, and the effect similar to that by prolonging the drying section L2b can be obtained. Moreover, by prolonging also the drying section L2b, higher productivity (conveyance speed of the sheet S) can be handled, if the size Lp in the X-direction of the recording unit 16 is the same. At this time, the heater 433 of the second drying portion 40b is set to a capacity higher than that of the heater 433 of the first drying portion 40a in accordance with a required heat amount.

According to the recording apparatus 1 of Embodiment 1, the horizontal section L3a in which the sheet S is conveyed in the horizontal attitude for a predetermined distance is set immediately on the downstream of the first recording portion 7a with the large maximum application amount. Therefore, movement of the ink applied to the sheet S along the inclination can be suppressed. Moreover, the first recording unit 16a and the second recording unit 16b are disposed such that the positions in the vertical direction are different and the projections in the vertical direction overlap with each other at least partially. Therefore, since the first recording unit 16a and the second recording unit 16b are disposed by being aligned in the vertical direction, the size in the horizontal direction can be suppressed even in the configuration having two recording units. Moreover, the first recording unit 16a and the second recording portion 7b of the second recording unit 16b are disposed at a first height, and the second drying portion 40b and the second cooling portion 50b of the second recording unit 16b are disposed at a second height. Therefore, there are fewer units disposed at the second height, and the size of the second drying portion 40b can be made larger, while the size in the horizontal direction of the entire recording apparatus 1 is suppressed. As a result, the drying performance of the second drying portion 40b can be improved, while a size increase in the horizontal direction is suppressed, whereby the conveyance speed can be made higher.

Note that, the conveyance direction SD8a of the first recording unit 16a and the second recording portion 7b and the conveyance direction SD8b of the second drying portion 40b and the second cooling portion 50b of the second recording unit 16b are not limited to the horizontal direction (X-direction) as in Embodiment 1. The conveyance directions SD8a, SD8b may be inclined to the horizontal direction as long as the horizontal direction components of the both are opposite to each other. In that case, too, since the horizontal section L3a is ensured in the first recording unit 16a, flow of the ink along the inclined conveyance direction SD8a can be suppressed, even if the ink in the maximum application amount W1 is applied in the first recording portion 7a. Moreover, the example in which the conveyance path is folded back downward on the downstream of the second recording portion 7b is illustrated in Embodiment 1, but it may be configured to be folded back upward.

Note that, in Embodiment 1, the example in which the first recording unit is located on the upstream of the second recording unit in the conveyance direction is illustrated, but the first recording unit may be located on the downstream of the second recording unit in the conveyance direction. Moreover, in Embodiment 1, the example in which at least a part of the first recording unit is disposed above at least a part of the second recording unit is illustrated, but it may be so configured that at least a part of the first recording unit is disposed below at least a part of the second recording unit.

### Control of Recording Apparatus

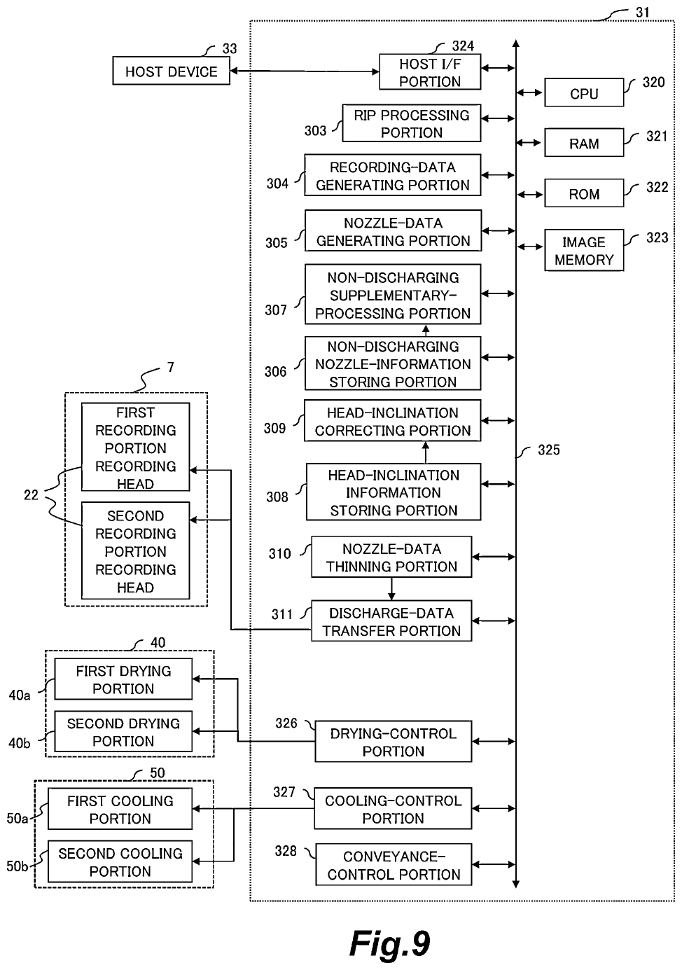

Subsequently, by using FIG. 9, a functional configuration of the recording apparatus 1 in Embodiment 1 will be explained. The control portion 31 has a host I/F portion 324. Via the host I/F portion 324, print data input from the host device 33 is rendered by an RIP processing portion 303 and becomes multivalued bitmap data. The print data input here is constituted by PDL (Page Description Language), for example. The multivalued bitmap data is subjected to ink-color conversion, quantization processing in a recording-data generating portion 304 and becomes halftone data in the ink color. The halftone data is assigned to each nozzle by each color by a nozzle-data generating portion 305 and becomes nozzle data (binary data) in the number of nozzles for each line. For the nozzle data, in accordance with non-discharging nozzle information stored in a non-discharging nozzle-information storing portion 306, non-discharging supplementary processing (processing to re-assign the discharge data assigned to the non-discharging nozzle to a nozzle which is not the non-discharging nozzle) is executed in a non-discharging supplementary-processing portion 307. The nozzle data subjected to the non-discharging supplementary processing is subjected to head-inclination correction (correction to move the data in the conveyance direction in accordance with an inclination amount) at a head-inclination correcting portion 309 in accordance with head-inclination information stored in the head-inclination information-storing portion 308. The nozzle data subjected to the head-inclination correction as above is stored in an image memory 323. A CPU 320 transfers the nozzle data stored in the image memory 323 to a nozzle-data thinning portion 310. The transferred nozzle data after the inclination correction is subjected to the thinning processing by the nozzle-data thinning portion 310 and is transferred by a discharge-data transfer portion 311 to each recording head 22 of the first recording portion 7a and the second recording portion 7b. Moreover, the CPU 320 executes control to each of the aforementioned units (not shown in FIG. 9). This control is executed on the basis of a control program stored in a ROM 322. The control program stored in this ROM 322 includes an OS for time sharing control by a load module unit called a task by a system clock. As a work area of the CPU 320, a RAM 321 is used. Each part including the CPU 320 is connected to a system bus 325.

Moreover, the control portion 31 has a drying-control portion 326, a cooling-control portion 327, and a conveyance-control portion 328. The drying-control portion 326 executes drive control or the like of temperatures of the first drying portion 40a and the second drying portion 40b, and the air blower. The cooling-control portion 327 controls cooling operations of the first cooling portion 50a and the second cooling portion 50b. The conveyance-control portion 328 controls a conveyance unit from the unwinding roll portion 2 to the winding roll portion 14 (the rewinding roll portion 2, the first dancer portion 3, the first main-conveying portion 4, the meandering correcting portion 5, the conveyance detecting portion 6, the conveyance-tension detecting portion 9, the second main-conveying portion 12, the second dancer portion 13, the winding roll portion 14). And the sheet S is conveyed at a predetermined conveyance speed. When the print data is input from the host device 33, a drive table shown in Table 1 is applied to each unit with respect to the drying-control portion 326, the cooling-control portion 327, the conveyance-control portion 328 on the basis of the print data.

TABLE 1

| | | | | | Second Recording Unit | | |
|---|---|---|---|---|---|---|---|
| | | First Recording Unit | | | Second | Second | Second |
| Condition | Conveyance | First Recording | First Drying | First Cooling | Recording | Drying | Cooling |
| No. | Speed | Portion | Portion | Portion | Portion | Portion | Portion |
| Condition 1 | V1 | CP11 | CD11 | CC11 | — | — | — |
| Condition 2 | V2 | CP12 | CD12 | CC12 | CP22 | CD22 | CC22 |
| Condition 3 | V3 | — | — | — | CP23 | CD23 | CC23 |

[symbol]

| | | | | | | | |
|---|---|---|---|---|---|---|---|
| Condition N | VN | CP1N | CD1N | CC1N | CP2N | CD2N | CC2N |

In the drive table, predetermined values based on the recording conditions such as image data, types of the sheet S and the like or values input by a user through the operation portion 32 and the like are registered. For example, under the condition 1 in Table 1, recording processing of only the first recording unit 16a is executed. In the first recording portion 7a, a moving operation and the like of the recording head 22 in the predetermined number of colors under the condition specified in a drive condition CP11 of the first recording portion 7a in Table 1 is performed. In the first drying portion 40a, drive control of a drying temperature and the air blower is executed under the condition specified in a drive condition CD11 of the first drying portion 40a in Table 1. In the first cooling portion 50a, the cooling control is executed under the condition specified in a drive condition CC11 of the first cooling portion 50a in Table 1. In Table 1, the symbol “-” indicates that each unit is in a standby state and is not involved in the recording processing. By executing the control based on the recording condition, preferable recording processing according to the image data, the recording medium, required productivity and the like can be realized.

### Embodiment 2

Subsequently, Embodiment 2 will be explained. Note that, in the following explanation, configurations similar to Embodiment 1 are given common signs with Embodiment 1, and explanation will be omitted as appropriate. Embodiment 2 is different from Embodiment 1 in the disposition of the first fixing portion 8a and the second fixing portion 8b.

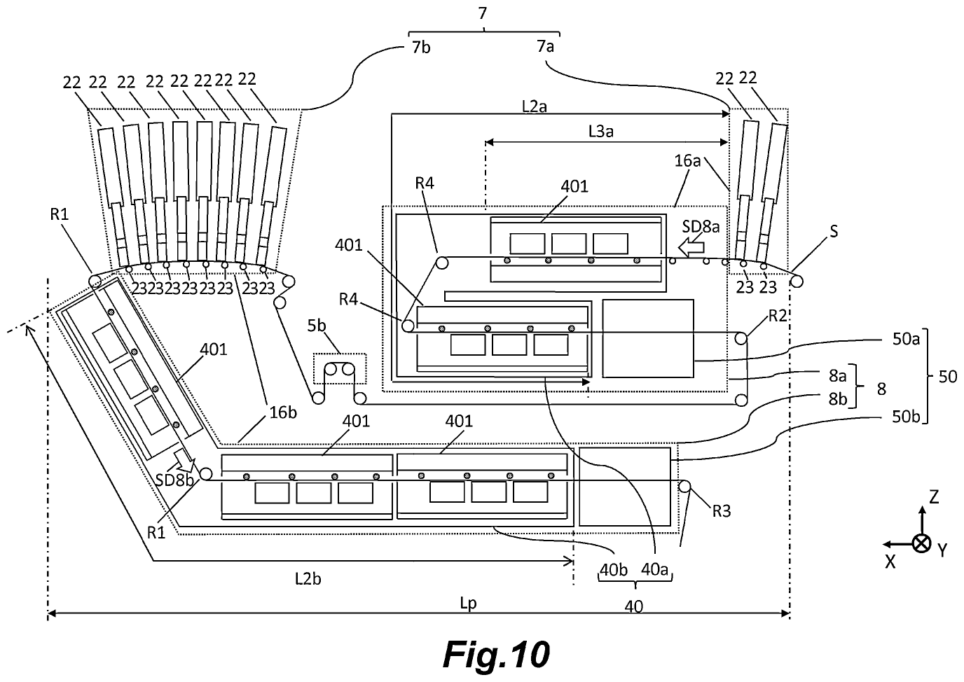

FIG. 10 is a schematic diagram showing a relative positional relation between the first recording unit 16a and the second recording unit 16b. In the first fixing portion 8a, in the first drying portion 40a, on the downstream from the horizontal section L3a in the conveyance direction, the conveyance path is folded back downward by a winding guide-roller R4, whereby the drying section L2a is formed. Moreover, in the second fixing portion 8b, the drying section L2b of the second drying portion 40b is formed also between two pieces of the winding guide-rollers R1. According to Embodiment 2, the drying sections L2a, L2b longer than those in Embodiment 1 can be ensured, while the length Lp in the horizontal direction of a region obtained by projecting a region occupied by the first recording unit 16a and the second recording unit 16b in the recording apparatus 1 in the vertical direction is approximately the same as that of Embodiment 1. Since the drying section can be made longer, time required for drying can be ensured even if the conveyance speed of the sheet S is increased. Thus, while the size Lp in the X-direction of the recording unit 16 is suppressed, higher productivity can be handled. Note that, in Embodiment 2, too, the drying section L2a and the horizontal section L3a are determined so as to satisfy the formula 1 and the formula 2 in Embodiment 1. Moreover, the disposition of each unit and the number of disposed units can be arbitrarily adjusted. For example, the number of the housings 401 in the drying portion 40 is not limited to Embodiment 2, but may be realized with an arbitrary installation number.

According to the present invention, in a recording apparatus including a plurality of recording units each having a recording portion which applies a liquid to a recording medium and a drying portion which dries the recording medium to which the liquid was applied, a size in the recording apparatus in the horizontal direction can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-104944, filed on Jun. 27, 2023, which is hereby incorporated by reference herein in its entirety.

What is claimed is:

1. A recording apparatus comprising:
a first recording unit having a first recording portion which performs recording by applying a liquid, while conveying a recording medium in a conveyance direction, and a first drying portion which is provided on a downstream of the first recording portion in the conveyance direction and dries the liquid applied to the recording medium; and
a second recording unit having a second recording portion which performs recording by applying the liquid, while conveying the recording medium in the conveyance direction, and a second drying portion which is provided on a downstream of the second recording portion in the conveyance direction and dries the liquid applied to the recording medium, wherein
recording on the recording medium with multiple types of the liquid can be performed separately for the first recording unit and the second recording unit,
in the recording apparatus, at least a part of the first recording unit and at least a part of the second recording unit are provided at different positions in a vertical direction, and at least a part of a region obtained by projecting a region, on which the first recording unit is disposed, in the vertical direction and at least a part of a region obtained by projecting a region, on which the second recording unit is disposed, in the vertical direction are overlapped in a horizontal direction; and
the recording medium conveyed out of the first recording portion is conveyed in a horizontal attitude until the recording medium has passed a predetermined distance in the first drying portion.

2. The recording apparatus according to claim 1, wherein
a horizontal component of a conveyance direction of the recording medium in the at least a part of the first recording unit and a horizontal component of a conveyance direction of the recording medium in the at least a part of the second recording unit are opposed to each other.

3. The recording apparatus according to claim 1, wherein
when the recording medium having passed the predetermined distance in the first drying portion is in an attitude inclined from the horizontal, the liquid having been applied to the recording medium does not move along the inclination.

4. The recording apparatus according to claim 1, wherein
a maximum application amount of the liquid by the first recording portion is larger than a maximum application amount of the liquid by the second recording portion.

5. The recording apparatus according to claim 4, wherein
when the recording medium, to which the liquid of an amount equal to or smaller than the maximum application amount of the second recording portion has been applied in the second recording portion, is inclined from the horizontal, the liquid having been applied to the recording medium does not move along the inclination.

6. The recording apparatus according to claim 1, wherein
the first recording unit as well as the second recording portion and the second drying portion are provided at different positions in a vertical direction, and at least a part of a region obtained by projecting a region, on which the first recording unit and the second recording portion are disposed, and at least a part of a region obtained by projecting a region, on which the second drying portion is disposed, in the vertical direction overlap with each other in the horizontal direction.

7. The recording apparatus according to claim 6, wherein
a horizontal component of a conveyance direction of the recording medium in the first recording unit and the second recording portion, and a horizontal component of a conveyance direction of the recording medium in the second drying portion are opposed to each other.

8. The recording apparatus according to claim 7, wherein
a horizontal component of the conveyance direction of the recording medium is reversed on a downstream of the second recording portion.

9. The recording apparatus according to claim 1, wherein
a distance over which the recording medium is conveyed in the second drying portion is longer than a distance over which the recording medium is conveyed in the first drying portion.

10. The recording apparatus according to claim 1, wherein
a heat amount applied to the recording medium in the second drying portion is larger than a heat amount applied to the recording medium in the first drying portion.

11. The recording apparatus according to claim 1, wherein
the recording apparatus is capable of performing recording on the recording medium without using the first recording unit; and
a conveyance speed when the recording is performed on the recording medium without using the first recording unit is faster than a conveyance speed when the recording is performed on the recording medium by using the first recording unit and the second recording unit.

12. The recording apparatus according to claim 1, wherein
the first recording unit has a first cooling portion which cools the recording medium; and
the first cooling portion is provided on a downstream of the first drying portion in the conveyance direction.

13. The recording apparatus according to claim 1, wherein
the second recording unit has a second cooling portion which cools the recording medium; and
the second cooling portion is provided on a downstream of the second drying portion in the conveyance direction.

14. The recording apparatus according to claim 1, wherein
the first recording portion applies white ink, a reaction liquid which increases fixability of ink, or the white ink and the reaction liquid to the recording medium; and
the second recording portion applies black ink, color ink, or the black ink and the color ink to the recording medium.

15. The recording apparatus according to claim 1, wherein
the first recording unit is located on an upstream of the second recording unit in the conveyance direction.

16. The recording apparatus according to claim 1, wherein
the first recording unit is located on a downstream of the second recording unit in the conveyance direction.

17. The recording apparatus according to claim 1, wherein
the at least a part of the first recording unit is disposed above at least a part of the second recording unit.

18. The recording apparatus according to claim 1, wherein
the at least a part of the first recording unit is disposed below at least a part of the second recording unit.
